(19) United States
(12) Patent Application Publication
(10) Pub. No.: US 2019/0390565 A1
(43) Pub. Date: Dec. 26, 2019

(54) DEVICE AND PROCESS FOR THE DETERMINATION OF AT LEAST ONE ROTATION PARAMETER OF A ROTATING DEVICE

(71) Applicant: ROLLS-ROYCE DEUTSCHLAND LTD & CO KG, Blankenfelde-Mahlow (DE)

(72) Inventors: Sebastian NOWOISKY, Michendorf (DE); Mateusz GRZESZKOWSKI, Berlin (DE)

(21) Appl. No.: 16/452,069

(22) Filed: Jun. 25, 2019

(30) Foreign Application Priority Data
Jun. 26, 2018 (DE) 10 2018 115 354.6

(51) Int. Cl. F01D 21/00; G01M 15/14

(52) U.S. Cl. CPC F01D 21/003; F05D 2270/44; F05D 2220/323; G01M 15/14

(57) ABSTRACT

A device for determining at least one rotation parameter (φ(k)) of a rotating device, in particular in a turbo engine, wherein a sensor device for measuring at least one oscillation signal (u(t)) of the rotating device, and a model-based estimation device for the at least one rotation parameter (φ(k)), wherein the oscillation signal (u(t)) can be used in the input data for the model-based estimation device. The invention also relates to a method.

The present disclosure relates to a device for determining at least one rotation parameter of a rotating device having the features of claim 1 and to a method for determining at least one rotation parameter of a rotating device having the features of claim 10.

A task which arises with rotating devices is to sense operating parameters which are determined during operation. In this context, it is known e.g. from EP 2 538 182, to detect the rotational speed by means of the vibration measurements. From EP 1 445 617 it is known to detect the running speed by means of a model-based system.

This object is achieved by a device having the features of claim 1. The device serves here to determine at least one rotation parameter of a rotating device, in particular in a turbo engine. For this purpose, at least one sensor device is used to measure at least one oscillation signal of the rotating device, wherein the at least one oscillation signal serves as an input variable for a model-based estimation device for the at least one rotation parameter. The at least one sensor device can be used to determine information about the kinematics in the interior of the rotating device on the basis of the emitted oscillations. The rotating device has at least one component which rotates relative to the other parts. The model-based estimation device then permits the kinematic information of interest to be estimated from the oscillation signal by means of the model support.

In embodiments, Kalman filters or extended-Kalman filters can be used as a model-based estimation device. Kalman filters are suitable here for linear systems, and extended-Kalman filters are suitable for non-linear systems. Both filters use—in a known fashion—a data model which is stored in a data processing device and approximates e.g. the oscillation behavior of the rotating device. Therefore, e.g. the model-based estimation device can be coupled to a vibration model for the generated oscillations, in particular to a vibration model with quadrature amplitude modulation. It is also alternatively possible to use a point mass filter (PMF) or a Rao-Blackwellized point mass filter (RBPMF), which estimate the probabilities of a state space on the basis of a deterministic dot matrix. Particle filters can also be used for non-Gaussian distributions and also non-linear system dynamics and measuring dynamics.

The at least one rotation parameter can be e.g. an angular speed, a phase zero point or at least one transmission rotational angle. These parameters occur regularly in rotating devices. If a plurality of rotating parts are arranged e.g. in a transmission, each can take on separate rotational angles which become manifest in the oscillation behavior of the device.

Therefore, the rotating device can have, in particular, a transmission, in particular a planetary transmission, wherein the at least one oscillation signal which is generated by the rotating device is, in particular, proportional to the rotational speed of the rotating device.

The estimation device estimates the instantaneous relative rotational angle of a transmission shaft, e.g. on the basis of the extended-Kalman filter. The angular speed and angular acceleration are then determined from the rotational angle. If the starting point of the estimation is known with respect to an absolute shaft position, the absolute rotational angle of a transmission shaft can then also be determined from the estimated variables. If the state model (here vibration model) were to be extended with unknown unbalance of the transmission shaft, an estimation of the absolute rotational angle position would be conceivable without determination of a starting point of the rotational angle.

In another embodiment, the at least one sensor device has, for measuring at least one oscillation signal of the rotating device, a solid-borne sound sensor, an acceleration sensor and/or a strain gauge. These types of sensors can pick up the oscillation signals of the rotating device individually or in combination. Different sensors can be used for different frequency ranges here.

In this context, specific known properties of the rotating device can generate systematic measuring errors, which can be compensated by corresponding modelling. Therefore, in one embodiment, a model-based compensation device is used for systematic measurement errors, in particular in order to take into account known influences of the torsion behavior of shafts on the input and/or output of the transmission, known temperature influences and/or known static load parameters. In this way, the accuracy of the estimated rotation parameters can be improved. This model-based compensation device can automatically correct, in particular, the at least one rotation parameter on a periodic basis.

The at least one estimated rotation parameter can be used in a variety of ways. One embodiment of the device has a coupling to a monitoring device of the turbo engine and/or a controller of the turbo engine, wherein the at least one rotation parameter of a rotating device can be used as an input variable. Such a use can occur e.g. in a model-based controller.

The rotating device, such as e.g. a transmission, can be arranged here, in particular, in a turbo engine, a stationary gas turbine, a gas turbine engine or an aircraft engine.

In all these turbo engines, it is of interest to monitor or measure the internal kinematics of the rotating devices.

The object is also achieved by a method having the features of claim 10.

In this context, firstly at least one oscillation signal of a rotating device is measured by a sensor device.

Directly after this or else later, the measured at least one oscillation signal is used as an input variable for a model-based estimation device. In one embodiment of the method, e.g. a Kalman filter or an extended-Kalman filter can be used as a model-based estimation device.

The at least one estimated rotation parameter can be e.g. an angular speed, a phase zero point or at least one transmission rotational angle.

One embodiment of the method can also have a model-based compensation device for at least one systematic measuring error. This measuring error can be present e.g. on the basis of a known influence of the torsion behavior of shafts at the input and/or output of the transmission, on the basis of temperature influences and/or on the basis of known static load parameters. In particular, the model-based compensation device can automatically correct the at least one estimated rotation parameter on a periodic basis.

The at least one estimated rotation parameter can be used more widely by virtue of a coupling to a monitoring device of the turbo engine and/or a controller of the turbo engine, wherein the at least one rotation parameter of a rotating device is used in each case as an input variable

In addition, embodiments of the device can be used to monitor and/or control a transmission in a gas turbine engine for an aircraft, which comprises the following: a core engine comprising a turbine, a compressor, and a core shaft connecting the turbine to the compressor;

a fan which is positioned upstream of the core engine, wherein the fan comprises a plurality of fan blades; and

a transmission which can be driven by the core shaft, wherein the fan can be driven by means of the transmission at a lower rotational speed than the core shaft.

As noted elsewhere herein, the present disclosure may relate to a gas turbine engine, e.g. an aircraft engine. Such a gas turbine engine may comprise a core engine comprising a turbine, a combustor, a compressor, and a core shaft connecting the turbine to the compressor. Such a gas turbine engine may comprise a fan (with fan blades) which is positioned upstream of the core engine.

Arrangements of the present disclosure may be particularly, although not exclusively, beneficial for geared fans, which are driven via a transmission. Accordingly, the gas turbine engine can comprise a transmission which is driven via the core shaft and the output of which drives the fan in such a way that it has a lower potential speed than the core shaft. The input to the transmission may be effected directly from the core shaft, or indirectly via the core shaft, for example via a spur shaft and/or spur gear. The core shaft may be rigidly connected to the turbine and the compressor, such that the turbine and compressor rotate at the same rotational speed (with the fan rotating at a lower rotational speed).

The gas turbine engine as described and/or claimed herein can have any suitable general architecture. For example, the gas turbine engine may have any desired number of shafts that connect turbines and compressors, for example one, two or three shafts. Purely by way of example, the turbine connected to the core shaft can be a first turbine, the compressor connected to the core shaft can be a first compressor, and the core shaft can be a first core shaft. The core engine may further comprise a second turbine, a second compressor, and a second core shaft connecting the second turbine to the second compressor. The second turbine, the second compressor, and the second core shaft can be disposed with a view to rotating at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The transmission may be designed to be driven by the core shaft that is configured to rotate (for example in use) at the lowest rotational speed (for example the first core shaft in the example above). For example, the transmission may be designed to be driven only by the core shaft that is configured to rotate (for example in use) at the lowest rotational speed (for example only by the first core shaft and not the second core shaft, in the example above). Alternatively, the transmission may be designed to be driven by one or more shafts, for example the first and/or second shaft in the example above.

In a gas turbine engine as described and/or claimed herein, a combustor may be provided axially downstream of the fan and compressor or compressors. For example, the combustor may be directly downstream of (for example at the exit of) the second compressor, when a second compressor is provided. By way of a further example, the flow at the exit of the compressor can be provided to the inlet of the second turbine, when a second turbine is provided. The combustor may be provided upstream of the turbine(s).

The or each compressor (for example the first compressor and the second compressor as described above) can comprise any number of stages, for example multiple stages. Each stage may comprise a row of rotor blades and a row of stator blades, which may be variable stator blades (i.e. the angle of incidence may be variable). The row of rotor blades and the row of stator blades may be axially offset with respect to each other.

The or each turbine (for example the first turbine and the second turbine as described above) can comprise any number of stages, for example multiple stages. Each stage can comprise a row of rotor blades and a row of stator blades. The row of rotor blades and the row of stator blades may be axially offset with respect to each other.

Each fan blade may have a radial span extending from a foot (or a hub) at a radially inner gas-washed location, or from a 0% span position, to a tip with a 100% span position. The ratio of the radius of the fan blade at the hub to the radius of the fan blade at the tip may be less than (or of the order of magnitude of) any of the following: 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range bounded by two values in the previous sentence (i.e. the values may form upper or lower bounds). These ratios can commonly be referred to as the hub-to-tip ratio. The radius at the hub and the radius at the tip may both be measured at the leading edge (or axially forwardmost edge) of the blade. The hub-to-tip ratio refers, of course, to the gas-washed portion of the fan blade, i.e. the portion radially outside any platform.

The radius of the fan may be measured between the engine centerline and the tip of the fan blade at its leading edge. The diameter of the fan (which can generally be double the radius of the fan) can be larger than (or of the order of magnitude of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range bounded by any two of the values in the previous sentence (i.e. the values may form upper or lower bounds).

The rotational speed of the fan may vary in operation. Generally, the rotational speed is lower for fans with a larger diameter. Purely by way of a non-limitative example, the rotational speed of the fan at cruise conditions may be less than 2500 rpm, for example less than 2300 rpm. Purely by way of a further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of a further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a speed Uₜᵢₚ. The work done by the fan blades on the flow results in an enthalpy rise dH of the flow. A fan tip loading may be defined as dH/Uₜᵢₚ², where dH is the enthalpy rise (for example the average 1-D enthalpy rise) across the fan and Uₜᵢₚ is the (translational) speed of the fan tip, for example at the leading edge of the tip (which may be defined as fan tip radius at the leading edge multiplied by angular speed). The fan tip loading at constant speed conditions can be more than (or of the order of magnitude of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure can have any desired bypass ratio, where in the bypass ratio is defined as the ratio of the mass flow rate of the flow through the bypass duct to the mass flow rate of the flow through the core at constant speed conditions. In the case of some arrangements, the bypass ratio can be more than (or of the order of magnitude of): 10, 10.5, 11, 11.5, 12, 12.5, 13, 13.5, 14, 14.5, 15, 15.5, 16, 16.5, 17, 17.5 or 18. The bypass ratio may be in an inclusive range bounded by any two of the values in the previous sentence (i.e. the values may form upper or lower bounds). The bypass duct can be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of a non-limiting example, the overall pressure ratio of a gas turbine engine as described and/or claimed herein at constant speed can be greater than (or of the order of magnitude of): 35, 40, 45, 50, 55, 60, 65, 70, 75. The overall pressure ratio may be in an inclusive range bounded by any two of the values in the previous sentence (i.e. the values may form upper or lower bounds).

The specific thrust of an engine can be defined as the net thrust of the engine divided by the total mass flow through the engine. The specific thrust of an engine as described and/or claimed herein at constant speed conditions can be less than (or of the order of magnitude of): 110 Nkg⁻s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds). Such engines can be particularly efficient in comparison with conventional gas turbine engines.

A gas turbine engine as described and/or claimed herein can have any desired maximum thrust. Purely by way of a non-limiting example, a gas turbine as described and/or claimed herein can be capable of generating a maximum thrust of at least (or of the order of magnitude of): 160 kN, 170 kN, 180 kN, 190 kN, 200 kN, 250 kN, 300 kN, 350 kN, 400 kN, 450 kN, 500 kN or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15° C. (ambient pressure 101.3 kPa, temperature 30° C.), with the engine static.

In use, the temperature of the flow at the entry to the high-pressure turbine can be particularly high. This temperature, which may be referred to as TET, may be measured at the exit to the combustor, for example immediately upstream of the first turbine blade, which itself may be referred to as a nozzle guide blade. At constant speed, the TET can be at least (or of the order of magnitude of): 1400 K, 1450 K, 1500 K, 1550 K, 1600 K or 1650 K. The TET at constant speed may be in an inclusive range bounded by any two of the values in the previous sentence (i.e. the values may form upper or lower bounds). The maximum TET in the use of the engine can be at least (or of the order of magnitude of), for example: 1700 K, 1750 K, 1800 K, 1850 K, 1900 K, 1950 K or 2000 K. The maximum TET may be in an inclusive range bounded by any two of the values in the previous sentence (i.e. the values may form upper or lower bounds). The maximum TET can occur, for example, at a high thrust condition, for example at a maximum take-off thrust (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fiber. By way of a further example at least a part of the fan blade and/or aerofoil may be manufactured at least in part from a metal, such as a titanium-based metal or an aluminum-based material (such as an aluminum-lithium alloy) or a steel based material. The fan blade may comprise at least two regions manufactured using different materials. For example, the fan blade may have a protective leading edge, which is manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fiber or aluminum-based body (such as an aluminum-lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disk). Purely by way of example, such a fixture may be in the form of a dovetail that may slot into and/or be brought into engagement with a corresponding slot in the hub/disk in order to fix the fan blade to the hub/disk. By way of a further example, the fan blades may be formed integrally with a central portion. Such an arrangement can be referred to as a blisk or a bling. Any suitable method can be used to manufacture such a blisk or such a bling. For example, at least a part of the fan blades may be machined from a block and/or at least part of the fan blades may be attached to the hub/disk by welding, such as linear friction welding.

The gas turbine engines described and/or claimed herein may or may not be provided with a variable area nozzle (VAN). Such a variable area nozzle may allow the exit area of the bypass duct to be varied in operation. The general principles of the present disclosure can apply to engines with or without a VAN.

The fan of a gas turbine as described and/or claimed herein may have any desired number of fan blades, for example 16, 18, 20, or 22 fan blades.

As used herein, cruise conditions may mean the cruise conditions of an aircraft to which the gas turbine engine is attached. Such constant speed conditions can be conventionally defined as the conditions at mid-cruise, for example the conditions experienced by the aircraft and/or the engine at the midpoint between (in terms of time and/or distance) the top of an ascent and the start of a descent.

Purely by way of example, the forward speed at the constant speed condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of magnitude of Mach 0.8, of the order of magnitude of Mach 0.85 or in the range of from 0.8 to 0.85. Any single speed within these ranges may be the cruise condition. For some aircraft, the cruise condition may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700m (around 35000 ft) to 11300m, for example in the range of from 10800 m to 11200 m, for example in the range of from 10900 m to 11100 m, for example of the order of magnitude of 11000 m. The constant speed conditions can correspond to standard atmospheric conditions at any given altitude in these ranges.

Purely by way of example, the cruise conditions may correspond to the following: a forward Mach number of 0.8, a pressure of 23000 Pa and a temperature of −55°C.

As used anywhere herein, “constant speed” or “constant speed conditions” can mean the aerodynamic design point. Such an aerodynamic design point (or ADP) may correspond to the conditions (comprising, for example, one or more of the Mach number, environmental conditions and thrust requirement) for which the fan is designed to operate. This may mean, for example, the conditions at which the fan (or the gas turbine engine) is designed to have optimum efficiency.

In operation, a gas turbine engine described and/or claimed herein may operate at the cruise conditions defined elsewhere herein. Such cruise conditions may be determined by the cruise conditions (for example the mid-flight conditions) of an aircraft on which at least one (for example two or four) gas turbine engine(s) may be mounted in order to provide propulsive thrust.

The skilled person will appreciate that, except where mutually exclusive, a feature or parameter described in relation to any one of the above aspects may be applied to any other aspect. Furthermore, any feature or any parameter described here can be applied to any aspect and/or combined with any other feature or parameter described here, unless they are mutually exclusive.

Embodiments will now be described by way of example with reference to the figures, of which:

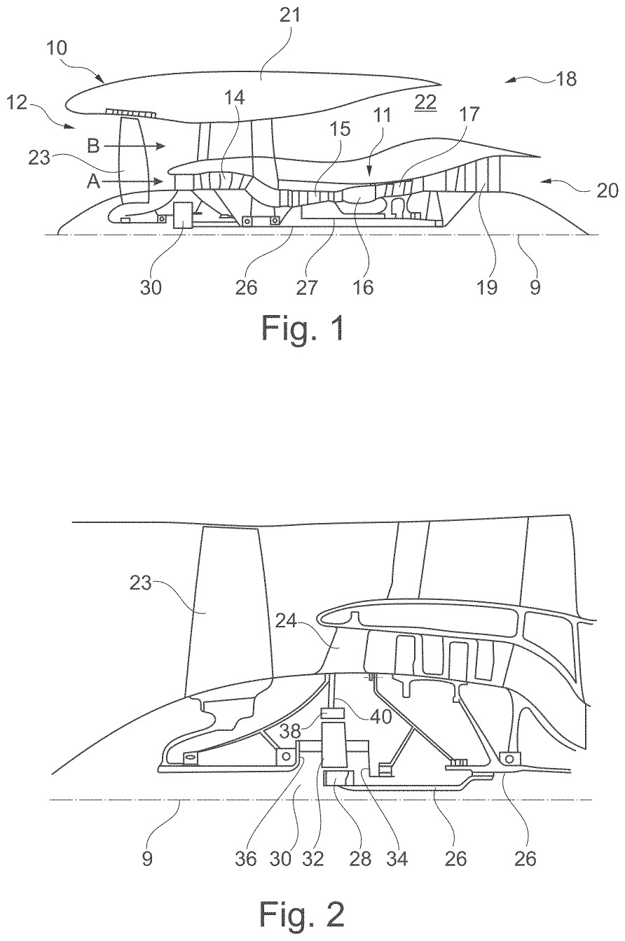

FIG. 1 shows a sectional lateral view of a gas turbine engine;

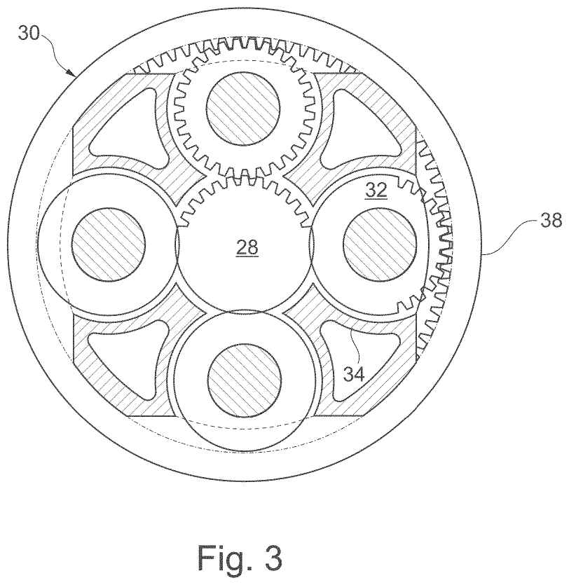

FIG. 2 shows a close-up sectional lateral view of an upstream portion of a gas turbine engine;

FIG. 3 shows a partially cut-away view of a transmission for a gas turbine engine;

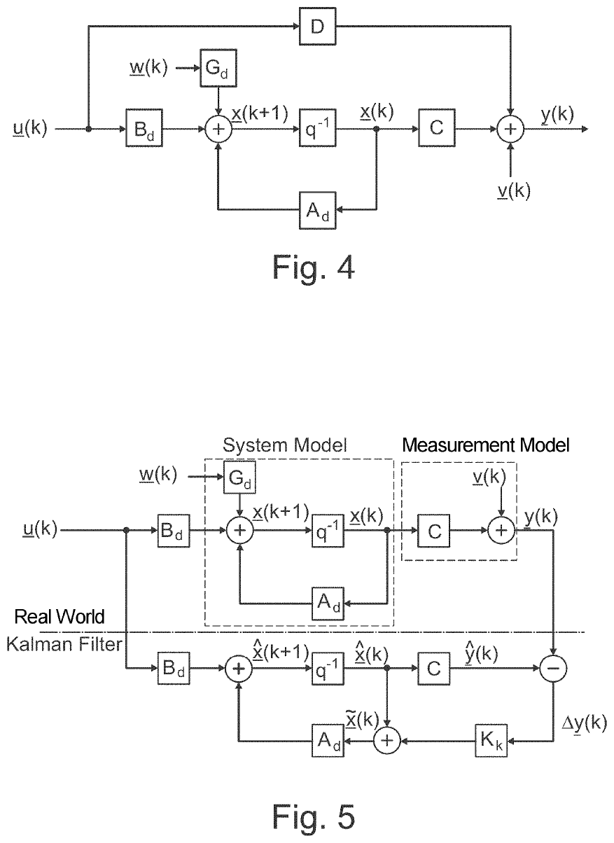

FIG. 4 shows a general system description in the state space taking into account the process noise w(k) and measurement noise v(k);

FIG. 5 shows an illustration of a Kalman filter block diagram;

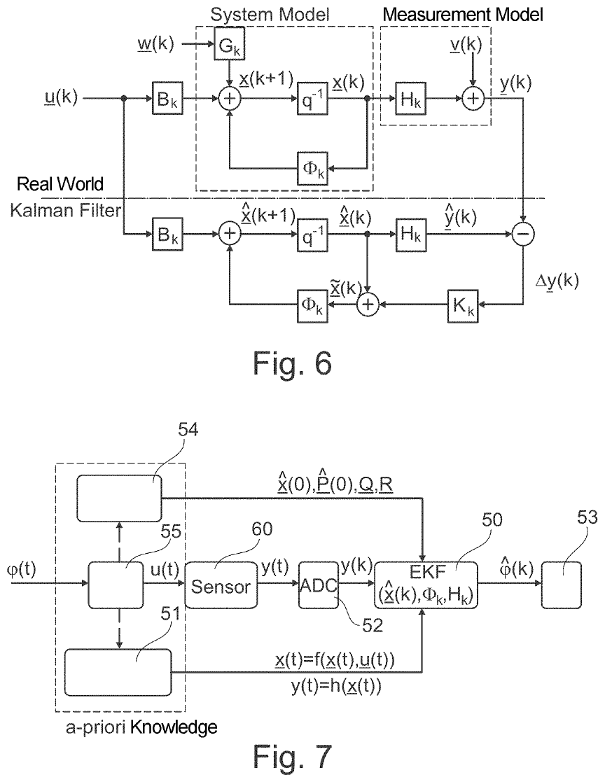

FIG. 6 shows an illustration of a block diagram for an extended Kalman filter (EKF);

FIG. 7 shows a signal flow chart for an EKF tracking algorithm;

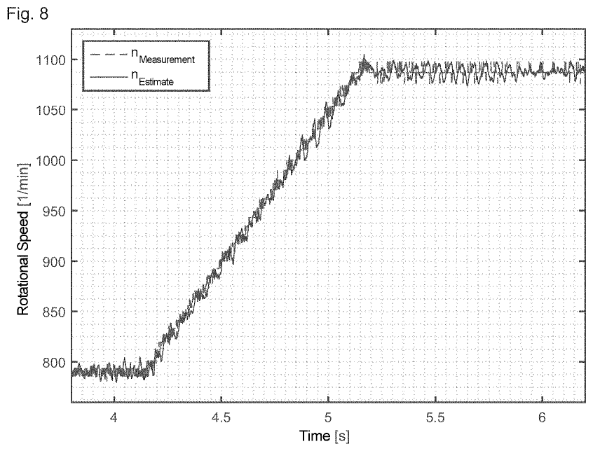

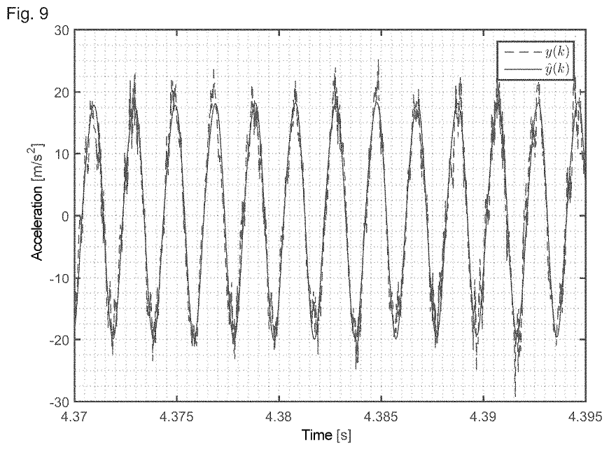

FIG. 8 shows an illustration of a rotational speed estimation for a running-up transmission rotational speed, a measured rotational speed signal profile (measurement-dashed line, estimation-continuous line)

FIG. 9 shows an illustration of a comparison between a measured acceleration signal and an estimated acceleration signal;

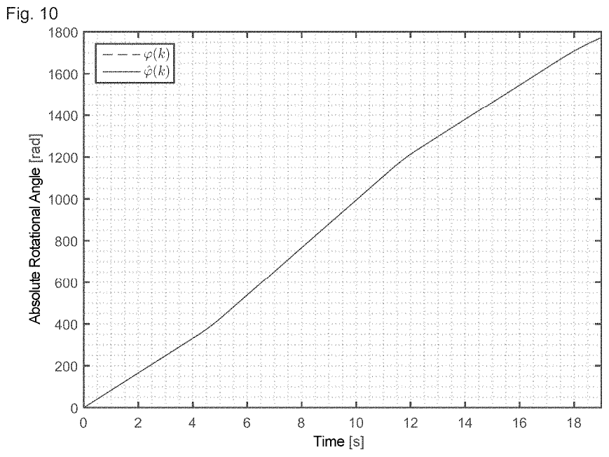

FIG. 10 shows an illustration of a comparison between a measured rotational angle and an absolute rotational angle;

FIG. 1 represents a gas turbine engine 10 having a main axis of rotation 9. The gas turbine engine 10 comprises an air intake 12 and a fan 23 that generates two airflows: a core airflow A and a bypass airflow B. The gas turbine engine 10 comprises a core 11 that receives the core airflow A. When viewed in the order corresponding to the axial direction of flow, the core engine 11 comprises a low-pressure compressor 14, a high-pressure compressor 15, a combustion device 16, a high-pressure turbine 17, a low-pressure turbine 19 and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 via a shaft 26 and an epicyclic planetary transmission 30.

In operation, the core airflow A is accelerated and compressed by the low-pressure compressor 14 and directed into the high-pressure compressor 15 where further compression takes place. The compressed air expelled from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being expelled through the nozzle 20 to provide some thrust force. The high-pressure turbine 17 drives the high-pressure compressor 15 by means of a suitable connection shaft 27. The fan 23 generally makes available the majority of the propulsive thrust. The epicyclic planetary transmission 30 is a reduction transmission.

An exemplary arrangement for a geared fan gas turbine engine 10 is shown in FIG. 2. The low-pressure turbine 19 (see FIG. 1) drives the shaft 26, which is coupled to a sun gear 28 of the epicyclic planetary transmission 30. Radially outwardly of the sun gear 28 and meshing therewith are a plurality of planet gears 32 that are coupled to one another by a planet carrier 34. The planet carrier 34 guides the planet gears 32 in such a way that they synchronously circle around the sun gear 28 whilst enabling each planet gear 32 to rotate about its own axis. The planet carrier 34 is coupled via linkages 36 to the fan 23 in order to drive its rotation about the engine axis 9. Radially outwardly of the planet gears 32 and meshing therewith is an annulus or ring gear 38 that is coupled, via linkages 40, to a stationary supporting structure 24.

Note that the terms “low-pressure turbine” and “low-pressure compressor” as used herein may be taken to mean the turbine stage with the lowest pressure and the compressor stage with the lowest pressure (i.e. not including the fan 23) respectively and/or the turbine and compressor stages which are connected together by the interconnecting shaft 26 with the lowest rotational speed in the engine (i.e. not including the transmission output shaft which drives the fan 23). In some literature, the “low-pressure turbine” and the “low-pressure compressor” referred to herein can alternatively be known as the “intermediate-pressure turbine” and “intermediate-pressure compressor”. Where such alternative nomenclature is used, the fan 23 may be referred to as a first, or lowest-pressure, compression stage.

The epicyclic planetary transmission 30 is shown by way of example in greater detail in FIG. 3. Each of the sun gear 28, planet gears 32 and ring gear 38 comprise teeth on their periphery to allow intermeshing with the other gearwheels. However, for clarity only exemplary portions of the teeth are illustrated in FIG. 3. There are four planet gears 32 illustrated, although it will be apparent to the person skilled in the art that more or fewer planet gears 32 can be provided within the scope of protection of the claimed invention. Practical applications of an epicyclic planetary transmission 30 generally comprise at least three planet gears 32.

The epicyclic planetary transmission 30 illustrated by way of example in FIGS. 2 and 3 is a planetary transmission in which the planet carrier 34 is coupled to an output shaft via linkages 36, with the ring gear 38 being fixed. However, any other suitable type of planetary transmission 30 may be used. By way of a further example, the planetary transmission 30 may be a star arrangement, in which the planet carrier 34 is held fixed, with the ring gear (or annulus) 38 allowed to rotate. In such an arrangement the fan 23 is driven by the ring gear 38. By way of a further alternative example, the transmission 30 can be a differential transmission in which the ring gear 38 and the planet carrier 34 are both allowed to rotate.

It goes without saying that the arrangement shown in FIGS. 2 and 3 is by way of example only, and various alternatives are within the scope of protection of the present disclosure. Purely by way of example, any suitable arrangement may be used for locating the transmission 30 in the gas turbine engine 10 and/or for connecting the transmission 30 to the gas turbine engine 10. By way of a further example, the connections (such as the linkages 36, 40 in the FIG. 2 example) between the transmission 30 and other parts of the gas turbine engine 10 (such as e.g. the input shaft 26, the output shaft and the fixed structure 24) may have a certain degree of stiffness or flexibility. By way of a further example, any suitable arrangement of the bearings between rotating and stationary parts of the gas turbine engine 10 (for example between the input and output shafts of the transmission and the fixed structures, such as the transmission casing) may be used, and the disclosure is not limited to the exemplary arrangement of FIG. 2. For example, where the transmission 30 has a star arrangement (described above), the person skilled in the art would readily understand that the arrangement of output and support linkages and bearing positions would usually be different than that shown by way of example in FIG. 2.

Accordingly, the present disclosure extends to a gas turbine engine having any arrangement of transmission styles (for example star or epicyclic-planetary), support structures, input and output shaft arrangement, and bearing locations.

Optionally, the transmission can drive additional and/or alternative components (e.g. the intermediate-pressure compressor and/or a booster compressor).

Other gas turbine engines to which the present disclosure can be applied can have alternative configurations. For example, engines of this type can have an alternative number of compressors and/or turbines and/or an alternative number of connecting shafts. By way of a further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure can also apply to engines in which the flow through the bypass duct 22 and the flow through the core 11 are mixed, or combined, before (or upstream of) a single nozzle, which can be referred to as a mixed flow nozzle. One or both nozzles (whether mixed or split flow) can have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some assemblies, the gas turbine engine 10 may not comprise a transmission 30.

The geometry of the gas turbine engine 10, and components thereof, is/are defined by a conventional axis system, comprising an axial direction (which is aligned with the rotational axis 9), a radial direction (in the bottom-to-top direction in FIG. 1), and a circumferential direction (perpendicular to the view in FIG. 1). The axial, radial and circumferential directions are mutually perpendicular.

The transmission 30 in a gas turbine engine 10 is subjected to considerable loading, such that it is appropriate to monitor in order to detect damage. In this context, the gas turbine engine 10 is to be considered only as one example of a turbo engine. There can therefore also be transmissions in conjunction with stationary gas turbines.

One possible way of diagnosing damage to turbo engines, such as e.g. gas turbine engines, is the time-equidistant acquisition of oscillation measurement signals which are then subsequently sampled in synchronism with the rotational angle, so that subsequently the signals can be averaged in order to damp stochastic signal components.

Subsequently, inter alia a feature acquisition process is carried out in an order spectrum. However, for this purpose in addition to the oscillation sensor signals there is also a need for the instantaneous rotational angle of the transmission driveshaft or transmission output shaft to be acquired.

However, such rotational speed sensor data is not always available, since either the accessibility of the rotational shaft is restricted or specific optical and/or magnetic rotational angle sensors cannot be used owing to oil mist or strong vibrations.

Vibration-generating phenomena in a turbo engine are proportional to the rotational speed. Therefore, the instantaneous rotational speed can basically be reconstructed by means of suitable processing of the oscillation data. The methods which are used for this purpose can be categorized roughly into the two following groups: estimation algorithms and tracking algorithms.

The estimation algorithms which are presented below all have in common that they do not use any historical data but rather can infer the oscillation frequency solely on the basis of an instantaneous recording of the oscillation behavior.

The method presented in Bonnardot, et al., Use of the acceleration signal of a transmission in order to perform angular resampling (with limited speed fluctuation) in: Mechanical Systems and Signal Processing 19 (2005), No. 4, pages 766-785, initially calculates the analytical signal from the oscillation signal and subsequently acquires the instantaneous phase of the signal by means of a Hilbert transformation.

The disadvantage of this method is that the oscillation signals have to be pre-filtered and are therefore suitable only for rotational speed fluctuations with low intensity, since otherwise overlapping of the higher harmonics in the frequency spectrum occurs.

In contrast, the method MOPA (multi-order probabilistic approach) (see Peeters et al.: Vibration-based angular speed estimation for multi-stage wind turbine transmissions in: Journal of Physics: Conference Series 842 (2017), page 012053) is based on the evaluation of the instantaneous spectrum by means of the short-time Fourier transformation. In this context, a probability density function, which permits a statement to be made as to which excitation frequency is dominant within the respective window time steps, is calculated from the short-time spectrum. The respective transmission rotational speed can then be calculated back from the determined excitation frequencies, assuming that the excitation frequencies are proportional to the rotational speed.

In Iwanow et al.: A new method for diagnosing states on rotating machines at variable rotational speeds in: Technische Mechanik [Technical Mechanics], volume 19 (1999), issue 3, time/frequency analysis methods (e.g.: Kurzzeit-Fourierspektrum [Short-time Fourier spectrum], Wigner-Ville distribution, Choi-Williams distribution) are used to determine the time profile of a rotational-speed-dependent harmonic oscillation component for individual measuring intervals of a recorded machine oscillation.

In contrast, the method according to Combet et al.: A new method for the estimation of the instantaneous speed relative fluctuation in a vibration signal based on the short time scale transform in: Mechanical Systems and Signal Processing 23 (2009), No. 4, pages 1382-1397, is based on a short-time scale transform (STST). In this context, an instantaneous time scaling factor between this reference signal and an oscillation signal with an unknown rotational frequency is calculated using a reference oscillation signal. Therefore, the oscillation signal which is to be examined is transformed into a time scale spectrum, as result of which the rotational frequency of the rotating machine can be recovered for each time segment which is considered.

In contrast to the estimation algorithms mentioned above, the tracking algorithms use historical measurement data to estimate state data of a process. These can be position data or else the rotational frequency of a turbo engine.

One method (Lindfors et al.: 2016 IEEE Intelligent Vehicles Symposium (IV): Jun. 19-22, 2016, Piscataway, N.J.) uses a point mass filter to estimate the velocity of a vehicle from the acceleration sensor data which are applied in the vicinity of the driven wheels and compares the results with a particle filter. In this context, the state space of the process is presented as a discrete grid, such that each point on the grid represents a probability distribution function of the state.

To acquire features in turbo engines, the order spectrum is frequently acquired from the oscillation measuring data. For this purpose, particularly in the case of dynamic changes in rotational angle of a rotating machine, a rotational speed signal which is as precise as possible must be available.

Owing to the given requirements, the angular resolution is often too low to obtain a specific quality level of the order spectrum. In addition, it is not always possible to access suitable measuring points for the measurement of the rotational speed. This is because the transmission rotational speed should if possible be recorded close to the oscillation sensor in order to compensate as far as possible potential deviations in the rotational angle between the rotational speed sensor and the oscillation sensor as a result of torsional vibrations. Moreover, the use of robust and high-resolution rotational speed sensors is expensive. On the other hand, if the rotational speed is reconstructed from oscillation data, fewer fault-critical sensors have to be maintained, the rotational angle measuring system can be constructed in a more favorable and nevertheless redundant fashion, and there is no longer any need to compensate torsional vibrations by means of a spatially separate oscillation sensor and rotational speed sensor.

In the text which follows, a new way which is suitable for turbo engines, in particular for geared fan engines, is described on the basis of exemplary embodiments.

For this purpose, details are initially given on the state space description of linear dynamic systems and subsequently on the basis of state estimation by means of Kalman filters. The embodiments of the method and the device make use of model-based estimation devices, particular of a state estimation of non-linear dynamic systems by means of extended-Kalman filters (EKF) which are described below.

Dynamic systems can be described inter alia in the frequency domain using a transmission function or else in the time domain by means of differential equations. However, the latter has the advantages that extensive statements about the internal behavior of a system are possible and the system behavior is easy to determine using suitable initial conditions (see Marchthaler et al., Kalman filters: Introduction to state estimation and its application for embedded systems). Since the Kalman filter makes use of the specified advantages and is based on the system description in the state space, an explanation is given below as to how a system can be described in the state space. For this purpose, a system must firstly be formed)by means of differential equations, in order to be able to subsequently transfer into the state space representation.

If the input variable u(t) acts on a linear physical system, the system reacts with the output variable y(t). In the case of a multi-variable system, the variables are expressed by means of the vectors u(t) and y(t). The internal behavior of the system can be described by means of differential equations and can be described by means of the following equations:

\dot{x}(t)=A x(t)+B u(t) (1)

y(t)=C x(t)+D u(t) (2)

The equations apply to time-invariant, linear systems. The equation (1) is referred to as a state differential equation, and the equation (2) is referred to as an output equation. In this context, the specified vectors and matrices are designated as follows:

x(t): State vector

uu(t): Input vector of the system.

A: System matrix. Contains the coefficients of the state variables.

B: Input matrix or control matrix.

C: Output matrix or observation matrix. Describes effects of the system on the output.

D: Feedforward matrix: Describes engagement of the system (D=0 in systems which are not capable of changing suddenly).

y(t): Output vector of the system.

When a time-continuous system is transferred into the discrete state space representation, the physical systems must be represented in the discrete time domain by discretization over a fixed time increment of Tₛ. By means of this discretization step, the following are obtained for the system matrix and the input matrix

A_{d}=e^{AT}^{ₛ} (3)

B_{d}=∫₀^{T}^{ₛ}e^{Av}B dv (4)

Taking into account disruption of the system by process noise w(k) and the measurement by measurement noise v(k), the following equations were obtained for a time-invariant, linear, time-discrete system:

x(k+1)=A_{d}.x(k)+B_{d}.u(k)+G_{d}.w(k) (5)

y(k)=C.x(k)+D.u(k)+v(k) (6)

In this context it is assumed that the errors which occur can be described by white Gaussian-distribution noise. The discrete system description in the state space is illustrated in FIG. 4. Here, q⁻¹ describes a delay element which corresponds to an integrator in the continuous time domain. The delay element delays the values of the state vector chronologically by one sampled value.

A first example of a model-based estimation device which can be used in embodiments of the method and of the device is a Kalman filter.

Since systems which cannot change suddenly are considered exclusively here, the engagement matrix is set to D=0 below. FIG. 5 shows a classic Kalman filter structure. Here, in the top half of the figure the real physical system, composed of a system model and measurement model, is illustrated, and in the bottom half of the block diagram the Kalman filter structure, which is based on the top state space representation of the real system, is illustrated.

The Kalman filter structure serves to estimate the state vector x(k) of the linear physical system. Here, the model which is used firstly calculates the output variable +ŷ(k) of the system. Then, the estimated output variable +ŷ(k) is compared with the measured output variable y(k), and the difference Δy(k) is formed. The difference is weighted with the so-called Kalman gain K(k) and fed back to the state model again. The difference is obtained as:

Δy(k)=y(k)−C+\hat{x}(k) (7)

The Kalman gain serves here for correcting the estimated state vector \hat{x}(k).

The corrected estimated state vector is denoted by +\tilde{x}(k).

The two noise terms w(k) and v(k) are not explicitly estimated in the presented Kalman filter but instead integrated into the process model by means of the Kalman gain factor Kₖ.

The description of the physical system again provides one error term per model here, such that disruption of the system by process noise w(k) and disruption of the measurement by measuring noise v(k) are taken into account. The following 5 basic equations can be derived from the illustrated filter structure:

Prediction:

+\hat{x}(k+1)=A_{d}.+\tilde{x}(k)+B_{d}.u(k) 8)

+\tilde{P}(k+1)=A_{d}.+\tilde{P}(k). A_{d}^{T}+G_{d}mit Qₖ=Var(w(k)) (9)

Here +\hat{P} represents the covariance of the estimation error

+\tilde{ε}(k+1))=x(k+1)−+\tilde{x}(k+1) (10)

and Qₖ the covariance of the process noise.

Correction:

Kₖ=+\tilde{P}(k).C^{T}.(C.+\hat{P}(k).C^{T}+Rₖ)⁻¹ where Rₖ=Var(v(k)) (11)

+\tilde{x}(k)=+\hat{x}(k)+Kₖ.(y(k)−C. +\hat{x}(k)) (12)

+\tilde{P}(k)=(I−Kₖ.C).+\hat{P}(k) (13)

Here, +\hat{P} represents the covariance of the estimation error

+\tilde{ε}(k)=x(k)−+\tilde{x}K (14)

and Rₖ represents the covariance of the measuring noise.

In each time step, in the prediction step the next state is first estimated (a priori estimated values), and in the correction step the feedback gain factor K_{K} and the a posteriori estimated values +\tilde{x}(k) are calculated from the current measured value and the last estimation. In addition, the error covariance matrices are calculated in each time step +\tilde{P}(k) (a posteriori) and +\tilde{P}(k) (a priori).

However, the equations (8) to (13) apply only under the following boundary conditions (see Marchthaler et al.):

Estimation error +\tilde{ε}(k) and system noise w(k) are uncorrelated→Cov(+\tilde{ε}(k),w(k))=0

Estimation error +\hat{ε}(k) and measurement noise v(k) are uncorrelated→Cov(+\hat{ε}(k),v(k))=0

Measurement noise v(k) and estimation error +\hat{ε}(k) are free of mean values→E{v(k)}=0 and E{+\hat{ε}(k)}=0

The problem with a classic Kalman filter is the fact that the state transfer of k to k+1 is described by a linear system matrix and output matrix, wherein the model is limited to linear systems. Even if a Kalman filter can basically be used as a model-based estimation device in embodiments, non-linear system models are used below.

The non-linear system dynamics are therefore approximated linearly by a suitable Taylor series expansion about a working point. This measure gives rise to the expanded-Kalman filter (EKF).

It will be assumed that at first there is the following time-discreet, non-linear system model:

x(k+1)=ƒ(x(k), u(k))+Gₖ.w(k) (15)

In order to determine the covariance matrix of the estimation error, the system matrix is calculated by linearizing about the working point +\hat{x} by means of the following Jacobi matrix:

$${{Φ}_{k} = \frac{\partial \underline{f} ( \underline{x} ( k ) , \underline{u} ( k ) )}{\partial \underline{x}} \vert}_{\underline{x} = \underline{\hat{x}}} \qquad ( 16 )$$

In order to determine the Kalman gain factor and adapt the covariance matrix of the estimation error the measuring matrix is also linearized:

$${{H}_{k} = \frac{\partial \underline{h} ( \underline{x} ( k ) )}{\partial \underline{x} ( k )} \vert}_{\underline{x} ( k ) = \underline{\hat{x}} ( k )} \qquad ( 17 )$$

The following equation is used for the non-linear measuring model here:

y(k)=h(x(k)) +v(k) (18)

Finally, for the estimated state vector +\tilde{x}(k) which is corrected by K_{K} and the estimated system output +\tilde{y}(k) the following is obtained:

+\tilde{x}k)=ƒ(°ŝk), u(k))+Kₖ(y(k)−+ŷ(k)) (19)

+ŷ(k)=h(+\hat{x}(k)) (20)

FIG. 6 illustrates a block diagram of an EKF with a linearized process and measuring model. The following algorithm is obtained for the EKF from the presented adaptations:

Prediction

+\hat{x}(k+1)=η(+\hat{x}(k), u(k)) (21)

+\hat{P}(k+1)=Φₖ+\hat{P}(k)Φₖ^{T}+GₖQₖGₖ^{T} (22)

Correction

Kₖ=+\hat{P}(k).Hₖ.+\hat{P}(k).Hₖ^{T}+Rₖ)⁻¹ (23)

+\hat{x}(k)=+\hat{x}(k)+Kₖ.(y(k)−h(+\hat{x}(k))) (24)

+\hat{P}(k)=(I−Kₖ.Hₖ).+\hat{P}(k) (25)

In the text which follows, details are given on application examples in which rotation parameters which have been determined for a transmission in a turbo engine, such as e.g. rotational angles of one or more gearwheels, are determined. Basically, the embodiments of the method and of the device can also be used for other rotation parameters.

In this context, in the text which follows, the estimation of the rotational angle is described using an EKF on the basis of measured oscillations.

Oscillations at gear drives can be modelled with the following oscillation signal x(t) (see e.g. Nguyen, Phong D.: Beitrag zur Diagnostik der Verzahnungen in Getrieben mittels Zeit-Frequenz-Analyse [Contribution to the diagnostics of tooth systems in transmissions by means of time/frequency analysis, Technical University of Chemnitz, dissertation, 2002):

$$x ( t ) = {\sum }_{k} {A}_{k} \cdot sin ( 2 π {kf}_{z} t + {φ}_{k} ) \qquad ( 26 )$$

Here, k describes the harmonic of the oscillation, Aₖ describes the amplitude of the k-th harmonic and f_{z} describes the tooth engagement frequency. According to the theory of quadrature amplitude modulation, the oscillation signal presented in equation (26) can be described as a sum composed of the quadrature signal Q(t) and the in-phase signal I(t):

y(t)=Q(t)+I(t) (27)

The oscillation signal can therefore be described as follows:

$$\begin{matrix}A ( t ) \cdot sin ( 2 π ft + φ ( t ) ) = A ( t ) sin ( φ ( t ) ) \cdot sin ( 2 π ft ) + A ( t ) cos ( φ ( t ) ) \cdot cos ( 2 π ft ) & ( 28 ) \\ A ( t ) \cdot sin ( 2 π ft + φ ( t ) ) = I ( t ) \cdot sin ( 2 π ft ) + Q ( t ) \cdot sin ( 2 π ft + \frac{π}{2} ) & ( 29 )\end{matrix}$$

The presented quadrature model is used below to obtain the process model. Here, I(t) and Q(t) represent the first two states x₁ and x₂, and the angular speed represents the state to be determined x₃:

x₁=I(t)=A(t) sin(ϕ(t)) (30)

x₂=Q(t)=A(t)cos(ϕ(t)) (31)

x₃=ϕ(t) (32)

The model equations of the process model can be obtained as follows (see Bittanti et al., Frequency tracking via extended kalman filter: Parameter design in: Proceedings of the American Control Conference, June 2000 (2000)):

$$\begin{matrix}[ \begin{matrix}{x}_{1} ( k + 1 ) \\ {x}_{2} ( k + 1 ) \\ {x}_{3} ( k + 1 ) \\ {x}_{4} ( k + 1 ) \\ {x}_{5} ( k + 1 ) \\ {x}_{6} ( k + 1 ) \\ {x}_{7} ( k + 1 )\end{matrix} ] = f ( \underline{x} ) = [ \begin{matrix}{x}_{1} cos ( {x}_{3} ( k ) ) - {x}_{2} sin ( {x}_{3} ( k ) ) \\ {x}_{1} sin ( {x}_{3} ( k ) ) + {x}_{2} cos ( {x}_{3} ( k ) ) \\ ( 1 - ϵ ) {x}_{3} ( k ) \\ {x}_{4} cos ( 2 {x}_{3} ( k ) ) - {x}_{5} sin ( 2 {x}_{3} ( k ) ) \\ {x}_{4} sin ( 2 {x}_{3} ( k ) ) + {x}_{5} cos ( 2 {x}_{3} ( k ) ) \\ {x}_{6} cos ( 4 {x}_{3} ( k ) ) - {x}_{7} sin ( 4 {x}_{3} ( k ) ) \\ {x}_{6} sin ( 4 {x}_{3} ( k ) ) + {x}_{7} cos ( 4 {x}_{3} ( k ) )\end{matrix} ] & ( 33 ) \\ y ( k ) = h ( \underline{x} ) = {\sum }_{m = 1}^{7} {x}_{m} ( k ) & ( 34 )\end{matrix}$$

The state equation (33) describes a signal model with oscillations of the tooth engagement frequency and of the 1st and 2nd harmonics of the tooth engagement frequency. The variable E serves to make the state equation stable and is typically ε«1.

FIG. 7 shows the signal flow chart of the illustrated method. The individual signal blocks can be described as follows:
Input: At the input, a rotating device executes rotational movement with the rotational angle φ(t) owing to a drive torque. The aim is to estimate this rotational angle φ(t) from oscillation measurement data using the presented method.
Rotating device 55: In a turbo engine, basically any transmission 30 can be used as a rotating device 55. The transmission should preferably have gearwheels. It is important that the oscillations u(t) generated by the transmission are proportional to the rotational speed. With reference to FIGS. 2 and 3, it is possible to monitor and/or control e.g. a planetary transmission 30 by means of the embodiments presented here.
Vibration model 51: The vibration model 51 models the oscillations generated by the rotation of the transmission. In this context, a signal model which models the individual signal components is used.
Initialization 54: The EKF requires the initialization estimated variables [symbol] , [symbol] , Q und R for the first prediction step. These variables have to be predefined by prior knowledge of the process noise and measuring noise of the state variables by means of the expected rotational speed and expected covariance matrices.
Sensor device 60: The oscillations of the rotating machine are sensed by an oscillation sensor device. This can be, by way of example, an acceleration sensor, a solid-borne sound sensor or else a strain gauge. It is important for the application that the sensor device can sense the dynamic oscillations of the rotating machine.
ADC: The analog signals in the time domain (t) of the oscillation sensor device 60 are subsequently digitized by means of an analog/digital converter 52 and mapped in the time-discrete domain (k).
EKF: The EKF estimates the internal state vector °\hat{x}(k+1) of the system model using the non-linear system model f(x(t), u(t)) in each time step. By rearranging the state equation it is possible for the rotational angle \hat{φ}(k) to be determined therefrom. The non-linear system model originates from the vibration model 51. The equations of the system model in FIG. 6 are obtained from the vibration model which is based on a signal model in this application.

The three blocks Initialization 54, Turbo engine 55 und Vibration model 51 constitute the a priori knowledge.

In the case of the planetary transmission 30 (see FIGS. 2 and 3), the sensor device 60 is arranged on or in the transmission 30. The sensor device 60 can therefore be arranged, in particular, on the circumference of the ring gear 38. The rotating planet gears 32 and the rotating sun gear 28 generate oscillations which are sensed by the sensor device 60. For example, the kinematic principles of the planetary transmission 30 basically provide information about rotational speeds and rotational speed ratios. This information can be taken into account when setting up the vibration model 51.

In complex shaft systems, as illustrated e.g. in FIG. 2, the shafts always have a specific torsional spring constant, i.e. they are not completely stiff. This torsion property has an influence on the rotational-speed-synchronous resampling between the vibration sensor and the rotational speed sensor which are spatially separate from one another, since they can generate a systematic rotational angle measuring error of 0.3 to 1.5°. Since this systematic error is known, it can be taken into account by a compensation device 53 which calibrates each estimated rotational angle \hat{φ}(k) with a corresponding value.

After the model equations of the process have been obtained on the basis of the a priori knowledge about the rotating machine, the corresponding matrices can be transferred to the EKF. At the same time, the initialization parameters have to be defined and also transferred to the EKF. These steps only have to be carried out in advance before the actual estimation of the rotational angle. Then, the transfer of the time-discrete oscillation sensor values to the EKF takes place and the latter then estimates the phase of the rotating transmission shaft for each time step. The signal processing operation of the EKF method will be described in more detail below.

1. Initialization

Firstly, the transfer of the initialization parameters +\hat{x}(0), +\hat{P}(0), Q and R to the EKF takes place, so that in the first time step (the prediction step), the a priori state +\hat{x} and the a priori error covariance matrix +\hat{P} can be initialized with suitable estimated variables.

2. Prediction:

The EKF processes the initialization parameters and calculates the future error covariance matrix +\hat{P} and the future system state +\hat{x}(k+1) from the non-linear system model f(x(t), u(t)) using the Jacobi matrix Φₖ.

3. Correction

The predicted state and the predicted error covariance matrix are corrected in the correction step using the Kalman gain Kₖ. For this purpose, the Jacobi matrix Hₖ must be determined.

The steps (2) and (3) are carried out iteratively for each discrete measured value y(k). In Bonnardot et al.: Use of the acceleration signal of a transmission in order to perform angular resampling (with limited speed fluctuation) in: Mechanical Systems and Signal Processing 19 (2005), No. 4, pages 766-785, in addition to the estimation or tracking of the instantaneous rotational speed an absolute rotational angle is also determined.

However, for diagnostic purposes it is appropriate to determine not only the machine rotational speed but also the absolute instantaneous rotational angle from the oscillation signal, in order thereby also to be able to assign locally estimated damage to the damage location. However, in order to be able to use the method presented above also to estimate the absolute rotational angle, the system model must, as explained below, be adapted.

The first two states are not modelled, as hitherto, by means of the tooth engagement oscillations but rather contain the shaft rotational angle ϕ. In contrast, the subsequent states x₄ and x₆ directly model the tooth engagement oscillations, predefined by the number of teeth z and their harmonic oscillations.

$$\begin{matrix}[ \begin{matrix}{x}_{1} ( k + 1 ) \\ {x}_{2} ( k + 1 ) \\ {x}_{3} ( k + 1 ) \\ {x}_{4} ( k + 1 ) \\ {x}_{5} ( k + 1 ) \\ {x}_{6} ( k + 1 ) \\ {x}_{7} ( k + 1 )\end{matrix} ] = f ( \underline{x} ) = [ \begin{matrix}{x}_{1} cos ( {x}_{3} ( k ) ) - {x}_{2} sin ( {x}_{3} ( k ) ) \\ {x}_{1} sin ( {x}_{3} ( k ) ) + {x}_{2} cos ( {x}_{3} ( k ) ) \\ ( 1 - ϵ ) {x}_{3} ( k ) \\ {x}_{4} cos ( z \cdot {x}_{3} ( k ) ) - {x}_{5} sin ( z \cdot {x}_{3} ( k ) ) \\ {x}_{4} sin ( z \cdot {x}_{3} ( k ) ) + {x}_{5} cos ( z \cdot {x}_{3} ( k ) ) \\ {x}_{6} cos ( 2 z \cdot {x}_{3} ( k ) ) - {x}_{7} sin ( 2 z \cdot {x}_{3} ( k ) ) \\ {x}_{6} sin ( 2 z \cdot {x}_{3} ( k ) ) + {x}_{7} cos ( 2 z \cdot {x}_{3} ( k ) )\end{matrix} ] & ( 35 ) \\ y ( k ) = h ( \underline{x} ) = {\sum }_{m = 1}^{7} {x}_{m} ( k ) & ( 36 )\end{matrix}$$

The initialization parameters then have to be set to the basic shaft rotational speed. In this way it is possible to acquire the absolute rotational angle from the oscillation signal by means of the EKF.

Compared to the estimation algorithms, the embodiment of the method which is presented here has the advantage that it supplies constantly precise rotational speed signal data independently of the rotational speed profile. It is therefore also suitable for dynamic and complex rotational speed profiles.

FIG. 8 shows first results in which the rotational speed n of a spur gear has been acquired from the acceleration sensor data by means of the present invention. In this context it is apparent that the variance of the estimation error assumes continuously low values up to the initialization phase. It can be inferred from this that the presented method is equally suitable both for quasi-constant and for rising rotational speed profiles.

FIG. 9 shows the profile of the measured acceleration signal y(k) (dashed line) and of the estimated acceleration signal +ŷ (continuous line). Here it is apparent that a precise estimation is no longer possible in the case of excitation of higher harmonics above the 2nd harmonic. This is due to the fact that the process model has been set up only up to the 2nd harmonic of the tooth engagement frequency.

In contrast, FIG. 10 shows the measured absolute rotational angle ϕ of the driveshaft and the absolute rotational angle which is estimated using this method. The two rotational angle profiles, the measured one (dashed line) and the estimated one (continuous line), lie virtually ideally one on top of the other in the illustrated region, so that the different lines cannot be discerned.

It goes without saying that the invention is not limited to the above-described embodiments and various modifications and improvements can be made without departing from the concepts described herein. Any of the features can be used separately or in combination with any other features, as long as these are not mutually exclusive, and the disclosure extends to all combinations and sub combinations of one or more features which are described here and includes them.

### LIST OF REFERENCE SIGNS

9 Main axis of rotation

10 Gas turbine engine

11 Core engine

12 Air intake

14 Low-pressure compressor

15 High-pressure compressor

16 Combustion device

17 High-pressure turbine

18 Bypass thrust nozzle

19 Low-pressure turbine

20 Core thrust nozzle

21 Engine nacelle

22 Bypass duct

23 Fan

24 Stationary supporting structure

26 Shaft

27 Interconnecting shaft

28 Sun gear

30 Transmission

32 Planet gears

34 Planet carrier

36 Linkage

38 Ring gear

40 Linkage

50 Model-based estimation device

51 Vibration model

52 Analog/digital converter

53 Compensation device for systematic measuring errors

54 Initialization

55 Rotating device in Kalman filter flowchart

60 Sensor device

A Core airflow

B Bypass airflow

1. A device for determining at least one rotation parameter (\hat{φ}(t)) of a rotating device, in particular in a turbo engine, wherein
at least one sensor device for measuring at least one oscillation signal (u(t)) of the rotating device, and
a model-based estimation device for the at least one rotation parameter (\hat{φ}(k)) wherein the oscillation signal (u(t)) can be used in the input data for the model-based estimation device.

2. The device according to claim 1, wherein the model-based estimation device has a Kalman filter, an extended-Kalman filter, a point mass filter, a Rao-Blackwellized point mass filter or a particle filter.

3. The device according to claim 1, wherein the model-based estimation device is coupled to a vibration model for the generated oscillations, in particular to a vibration model with quadrature amplitude modulation.

4. The device according to claim 1, wherein the at least one rotation parameter is an angular speed, a phase zero point or at least one transmission rotational angle (\hat{φ}(t)).

5. The device according to claim 1, wherein the rotating device has a transmission, in particular a planetary transmission, wherein the at least one oscillation signal (u(t)) which is generated by the rotating device is, in particular, proportional to the rotational speed of the rotating device.

6. The device according to claim 1, wherein the at least one sensor device has, for measuring the at least one oscillation signal (u(t)) of the rotating device, a solid-borne sound sensor, an acceleration sensor and/or a strain gauge.

7. The device according to claim 1, wherein a model-based compensation device for systematic measurement errors, in particular for known influences of the torsion behavior of shafts on the input and/or output of the transmission, for known temperature influences and/or known static load parameters.

8. The device according to claim 7, wherein the model-based compensation device corrects the at least one rotation parameter (\hat{φ}(k)) periodically.

9. The device according to claim 1, wherein a coupling to a monitoring device of the turbo engine and/or a controller of the turbo engine wherein the at least one rotation parameter (\hat{φ}(k)) of a rotating device can be used as an input variable.

10. The device according to claim 1, wherein the turbo engine is a stationary gas turbine, a gas turbine engine or an aircraft engine.

11. A method for determining at least one rotation parameter (\hat{φ}(k)) of a rotating device, in particular in a turbo engine, wherein
A) measurement of at least one oscillation signal (u(t)) of the rotating device by at least one sensor device, wherein
B) the measured oscillation signal (u(t)) is used as input data for a model-based estimation device.

12. The method according to claim 11, wherein the model-based estimation device has a Kalman filter or an extended-Kalman filter.

13. The method according to claim 11, wherein the at least one estimated rotation parameter is an angular speed, a phase zero point or at least one transmission rotational angle (\hat{φ}(k)).

14. The method according to claim 11, wherein a model-based compensation device compensates at least one systematic measurement error, in particular on the basis of a known influence of the torsion behavior of shafts at the input and/or output of the transmission, on the basis of temperature influences and/or on the basis of known static load parameters.

15. The method according to claim 14, wherein the model-based compensation device automatically corrects the at least one rotation parameter (\hat{φ}(k)) on a periodic basis.

16. The device according to claim 11, wherein a coupling to a monitoring device of the turbo engine and/or a controller of the turbo engine wherein the at least one rotation parameter (\hat{φ}(k)) of a rotating device can be used as an input variable.

17. A gas turbine engine for an aircraft, comprising the following:
a core engine comprising a turbine, a compressor, and a core shaft connecting the turbine to the compressor;
a fan, which is positioned upstream of the core engine, wherein the fan comprises a plurality of fan blades; and
a transmission, which can be driven by the core shaft, wherein the fan can be driven by means of the transmission at a lower rotational speed than the core shaft, and a device according to claim 1 for monitoring and/or controlling the transmission.
